(19) United States
(12) Patent Application Publication
(10) Pub. No.: US 2009/0025814 A1
(43) Pub. Date: Jan. 29, 2009

(54) FLEXIBLE FLUID LINE AND METHOD FOR MANUFACTURING IT

(75) Inventor: Ole Olsson, Stoholm (DK)

Correspondence Address: MCCORMICK, PAULDING & HUBER LLP, CITY PLACE II, 185 ASYLUM STREET, HARTFORD, CT, 06103, US

(73) Assignee: PIFLEX P/S, Loegumkloster (DK)

(21) Appl. No.: 12/158,150

(22) PCT Filed: Dec. 23, 2005
(86) PCT No.: PCT/EP05/13988

§ 371 Date: Sep. 19, 2008

(51) Int. Cl. F16L 11/00; B23P 17/04

(52) U.S. Cl. 138/109; 29/592; 138/116; 138/120

(57) ABSTRACT

The invention specifies a flexible fluid line comprising a plurality of tubes (1) which are arranged parallel next to one another, which have a common connecting element (11, 12) at least one end (9, 10) and which are embedded in a plastic body (6). The invention also specifies a method for producing a fluid line (8) of this type. It is desirable to be able to produce a fluid line of this type in a simple manner. To this end, provision is made for a section of the tubes (1) which is located between the two ends (9, 10) to be bent in a meandering fashion.

### CROSS REFERENCE TO RELATED APPLICATIONS

This application is entitled to the benefit of and incorporates by reference essential subject matter disclosed in International Patent Application No. PCT/EP2005/013988 filed on Dec. 23, 2005.

### FIELD OF THE INVENTION

The invention concerns a flexible fluid line with several tubes arranged in parallel next to each other, the tubes having at least one end a common connecting element and being embedded in a plastic member. Further, the invention concerns a method for manufacturing a flexible fluid line in that several tubes are arranged in parallel next to each other, reshaped, embedded in a plastic material and provided at least one end with a common connecting element.

### BACKGROUND OF THE INVENTION

Such a fluid line is known from WO 2004/046601 A1. Here, the individual tubes are guided in a helical line shape and surround a hollow, which can be left free or filled by a core. The sum of the cross-sections of all tubes is available for the flow of the fluid. The helical line shaped guiding of the tubes provides the fluid line with a certain flexibility.

Such fluid lines are well suited for transporting fluids under high pressure and, if required, also under high temperatures in technical applications, when heavy vibrations, large relative movements and aggressive environments occur in connection with these applications. Application examples are mobile refrigeration systems, particularly CO₂ air-conditioning systems in vehicles. For mounting reasons, such applications require a certain flexibility of the line, without causing a weakening of the line.

However, the manufacturing of such fluid lines requires a certain effort. The tubes located next to each other must be wound in common around a core to create the helical line shape. This requires a certain skill. Manufacturing by means of machines is only possible to a limited extent. At best, machine-operated tools can be used.

### SUMMARY OF THE INVENTION

The invention is based on the task of providing a flexible fluid line, which is easy to manufacture.

With a flexible fluid line as mentioned in the introduction, this task is solved in that a section of the tubes located between the two ends is bent in a meandering fashion.

A meander shape, in which several waves are arranged in series in the longitudinal direction of the tubes, is substantially easier to manufacture as a winding along a helical line of several tubes arranged in parallel to each other. Firstly, the reshaping process is substantially simplified. Further, a fluid line with tubes bent in a meander shape is usually even more flexible than a fluid line, in which parallel tubes are wound along a helical line. Thus, the fluid line with meander shape has further advantages.

It is preferred that each tube comprises several arc sections in the shape of arcs of a circle. A shaping tool for generating arcs of a circle can easily be manufactured. The pistons required for the reshaping can then have the shape of a cylinder sleeve section. If required, the arc sections can also be connected to each other by means of straight sections. However, it will usually be sufficient for the arc sections to be immediately adjacent or to have small distances to each other.

Alternatively or additionally, it can be provided that each tube has several sine-shaped arc sections. With sine-shaped arc sections, a more favourable flow through the fluid line can be realised. With sine-shaped arc sections, the transition between two arc sections, which are curved in opposite directions, can be realised in such a manner that the tangent extends under an angle of less than 90° to the longitudinal extension of the fluid line. However, in principle, this is also possible with sections having the shape of an arc of a circle.

Preferably, a curvature radius of an arc section is in a range from 1.5 to 5×D, D being the outer diameter of a tube. With such a curvature radius, the individual tubes will not be overstrained by the bending. If an arc section in the shape of an arc of a circle is not concerned, the curvature radius is a middle curvature radius over an arc section.

It is preferred that a period length is in the range from 3 to 10×R, R being the curvature radius. The period length is the distance between two maximums of the meander shaped tube. Such a distance permits a sufficient extension or contraction of the line. If the distance is larger, the individual arc sections are somewhat extended, that is, if required they can comprise straight additional sections, which extend in parallel to the longitudinal axis. With arc sections, which have a pure circular line shape, and which are immediately adjacent to each other, the distance amounts to four curvature radii.

Preferably, the plastic material body has a meander-shaped extension. Thus, the plastic material body completely assumes the flexibility of the tube. A plastic material body following the meander shape of the tubes can be realised with a relatively low material consumption. The plastic material has a certain flexibility or elasticity, so that it can deform together with the tubes during vibrations or longitudinal changes.

Preferably, the tubes are arranged with an intermediary to each other, the intermediary being filled, at least partly by the plastic material of the plastic material body. Thus, the individual tubes are separated from each other by a thin plastic material layer. This prevents the tubes from rubbing on each other, if the fluid line is exposed to vibrations during operation. Thus, a mechanical wear is kept small. Further, a noise development can be prevented, or only small noises appear.

Preferably, one end of the fluid line is twisted in relation to the other end. The twist angle between the two ends preferably amounts to 90°. In this connection, the twist angle is the angle between a first plane, in which the tubes are arranged next to each other at one end of the fluid line, and a second plane, in which the tubes are arranged in parallel next to each other at the other end of the fluid line. The twisting of the two ends around the longitudinal axis of the fluid line provides a uniform movability of the line in all radial directions, that is, all the directions extending vertically to the longitudinal axis of the fluid line.

It is also advantageous, if the tubes are made of a metal, particularly steel or aluminium. This increases the stability of the fluid line. At the same cost, metal is more resistant to many fluids than a plastic material.

With a method as mentioned in the introduction, the task is solved in that a section located between the two ends of the tubes is bent to a meander shape.

A meander-shaped shaping is relatively easily realised, without requiring winding of the tubes.

Preferably, a pressing tool is used for the bending. A pressing tool is often available. It is merely required to use a suitable die for the meander-shaped bending.

Preferably, the tubes located in one plane are bent vertically to this plane. This is the simplest method of achieving the meander-shaped bending. Basically, only a movement in one direction is required.

Preferably, the tubes are provided with the plastic material before the reshaping. This simplifies the design of a tool, for example an injection moulding tool, for embedding the tubes in the plastic material. Basically, merely a mould is required, which has a square hollow. The plastic material does not prevent the bending of the tubes into a meander shape.

It is also advantageous if, after the reshaping the ends of the fluid line are twisted in relation to each other by a predetermined angle, preferably 90°. This will require an additional manufacturing step. However, the twisting of the two ends will cause an increased flexibility in all directions.

### BRIEF DESCRIPTION OF THE DRAWINGS

In the following, the invention is described on the basis of preferred embodiments in connection with the drawings, showing:

FIG. 1 is a top view of a fluid line without connecting elements and without plastic material with six parallel tubes,

FIG. 2 is a side view of the line according to FIG. 1,

FIG. 3 is a front view of the line according to FIG. 1,

FIG. 4 is the line according to FIG. 1 with plastic material body and connecting elements,

FIG. 5 is a side view of the line according to FIG. 4,

FIG. 6 is a front view of the line according to FIG. 4,

FIG. 7 is a schematic view of a line, in which the two connecting elements are twisted around the longitudinal axis by approximately 90° in relation to each other,

FIG. 8 is a schematic view explaining the period length dependency of the flexibility and the flow resistance of a line.

### DETAILED DESCRIPTION OF THE PREFERRED EMBODIMENTS

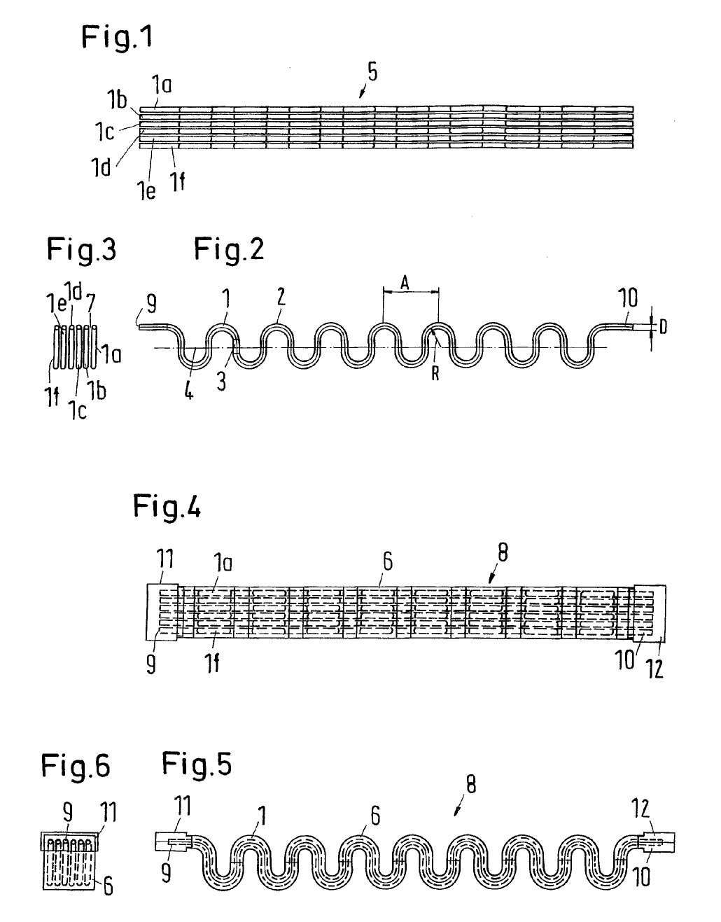

The FIGS. 1 to 3 show several tubes 1a-1f, which are located in parallel to each other. In the present case, six tubes 1a-1f are concerned. However, also more or less tubes can be used.

Each tube 1a-1f has an external diameter D, in the present embodiment amounting to 2.5 mm. In the present embodiment, the wall thickness of a tube 1a-1f amounts to 0.4 mm. Of course, also other values are possible.

As can be seen from FIG. 2, the tubes 1 are bent in a meander shape, meaning that they form a plurality of arc sections 2, which are adjacent to each other or connected by small, straight sections 3. The length of such a straight section 3 can, for example, be 4 mm. An arc section 2 must not necessarily have a continuous curvature, but can have smaller sections, not shown in detail, which are parallel to a longitudinal direction 4.

An arc section 2 has a radius R, which is in the range from 1.5 to 5×D, D being the external diameter of the tube 1 mentioned above. Preferably, with an external diameter D of 2.5 mm, the curvature radius is between 3.75 mm and 12.5 mm. In the present embodiment the curvature radius R is 6 mm.

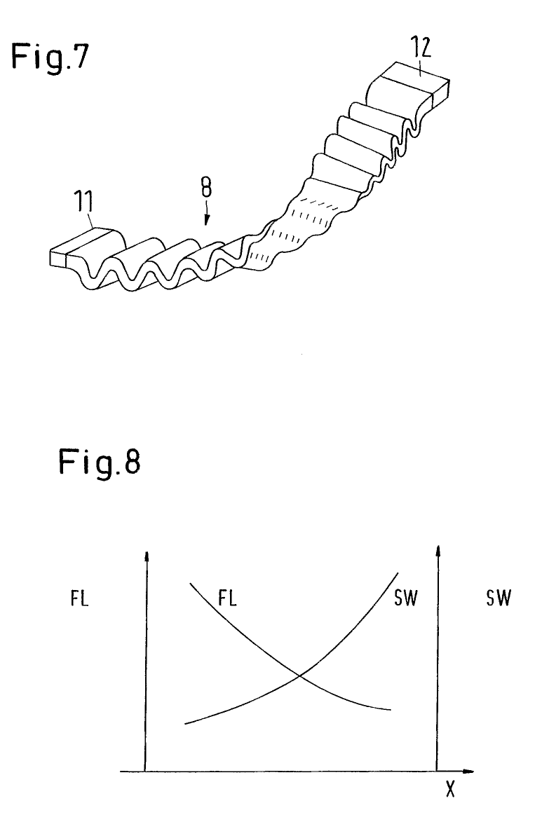

The arc sections 2 can be bent to the shape of a circular line. However, they can also have sine-shaped extension. It is not necessarily required that transition portions between two arc sections 2 are vertical to the longitudinal direction 4. Also an angle of, for example, 45°, which would appear at the transition between two sine-shaped arc sections, would be possible (FIG. 7).

A period length A, that is, the distance between two “maximums” or between two “zero positions”, that is, the crossing of a plane located in the centre in the longitudinal direction 4, preferably amounts to 3 to 10×R, R being the curvature radius mentioned above. In the present embodiment, the axial distance between two adjacent windings or waves, that is, the period length, is 24 mm.

If an arc section 2 in the shape of a circular line is not concerned, the radius R varies over an arc section 2. In this case, an average radius must be assumed.

As appears from the FIGS. 4 to 6, a tube group 5 formed by the tubes 1a-1f is embedded in a plastic material 6, which is resilient. The plastic material 6 forms a plastic material body. Between any two of the tubes 1a-1f there are small intermediaries 7, into which the plastic material 6 penetrates. In this way it is prevented that the tubes 1a-1f rub on each other, when the fluid line 8 shown in FIGS. 4 to 6 is deformed. Such a deformation may occur, if arrangements, which are connected to the two ends 9, 10 of the fluid line, change their relative position. Generally, this change of position can take place in all space directions.

At both ends 9, 10 of the fluid line 8 connecting elements 11, 12 are located, which can, for example, be moulded in one piece with the plastic material 6, or be connected to the tubes as separate components. The connecting elements 11, 12 comprise all tubes 1a-1f, and, apart from the supply and discharge of a fluid or the connection of an arrangement, they have the task of keeping the individual tubes 1a-1f in a defined position in parallel to each other.

In a simple manner, the manufacturing of such a fluid line 8 can be realised by means of a pressing tool. By means of the pressing tool, the tubes 1a-1f arranged adjacent to each other in one plane are deformed perpendicularly to this plane. The result can then be sections, which are sine-shaped or have the shape of the arc of a circle, and which can be manufactured in one single step. It is merely required that the shape of the tool is chosen so that the desired shape may be achieved.

Before reshaping the tubes 1a-1f, the plastic material 6 and also the connecting elements 11, 12, or the separate connecting elements, can be connected to the tubes. For this purpose, the tubes 1a-1f, located in one plane, in parallel and adjacent to each other, can be inserted in a corresponding injection mould, and the plastic material 6 can be injected. The reshaping can then be made after applying the plastic material 6.

As appears from FIG. 7, the two connecting elements 11, 12 can be twisted by, for example, 90° in relation to each other after the manufacturing of the fluid line 8 shown in FIG. 5, so that a relatively uniform movability of the fluid line in all radial directions is achieved.

The tubes 1a-1f are preferably made of steel or aluminium, but other metals can be imagined.

FIG. 8 is a schematic view of the dependency of a deformation resistance FL on the wave number X. In the embodiment of FIG. 5, the fluid line 8 has eight waves. With an increasing number of waves X, the deformation resistance FL is reduced.

On the other hand, the flow resistance SW increases, if the number of waves X increases, as, with the same length, the curvature radii of the waves will be reduced.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A flexible fluid line with several tubes arranged in parallel next to each other, the tubes having at least one end a common connecting element and being embedded in a plastic member, wherein a section of the tubes located between the two ends is bent in a meandering fashion.

2. The fluid line according to claim 1, wherein each tube comprises several arc sections in the shape of arcs of a circle.

3. The fluid line according to claim 1, wherein each tube has several sine-shaped arc sections.

4. The fluid line according to claim 2, wherein a curvature radius of an arc section is in a range from 1.5 to 5×D, D being the outer diameter of a tube.

5. The fluid line according to claim 4, wherein a period length is in the range from 3 to 10×R, R being the curvature radius.

6. The fluid line according to claim 1, wherein the plastic material body has a meander-shaped extension.

7. The fluid line according to claim 1, wherein the tubes are arranged with an intermediary to each other, the intermediary being filled, at least partly, by the plastic material of the plastic material body.

8. The fluid line according to claim 1, wherein one end of the fluid line is twisted in relation to the other end of the fluid line.

9. The fluid line according to claim 8, wherein a twisting angle between the ends amounts to 90°.

10. The fluid line according to claim 1, wherein the tubes are made of a metal, particularly steel or aluminium.

11. A method for manufacturing a flexible fluid line in that several tubes are arranged next to each other, reshaped, embedded in a plastic material and provided at least one end with a common connecting element, wherein a section located between the two ends of the tubes is bent to a meander shape.

12. The method according to claim 11, wherein a pressing tool is used for the bending.

13. The method according to claim 11, wherein the tubes located in one plane are bent perpendicularly to this plane.

14. The method according to claim 11, wherein the tubes are provided with the plastic material before the reshaping.

15. The method according to claim 11, wherein after the reshaping the ends of the fluid line are twisted in relation to each other by a predetermined angle, preferably 90°.
